(19) United States
(12) Patent Application Publication
(10) Pub. No.: US 2008/0152138 A1
(43) Pub. Date: Jun. 26, 2008

(54) AUDIO DATA TRANSMISSION METHOD FOR TRANSMITTING ENCRYPTED AUDIO DATA, AUDIO PROCESSING SYSTEM AND COMPUTER SYSTEM THEREOF

(76) Inventors: Shu-Yeh Chiu, Hsinchu County (TW); Loung-Wen Chiang, Chi-Lung City (TW); Tsung-Li Yeh, Peng-Hu Hsien (TW); Ti-En Lu, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/960,705

(22) Filed: Dec. 20, 2007

(30) Foreign Application Priority Data
Dec. 21, 2006 (TW) 095148249

(51) Int. Cl. H04L 9/28; H04N 7/167

(52) U.S. Cl. 380/210; 380/28

(57) ABSTRACT

The present invention provides an audio data transmission method for transmitting encrypted audio data, an audio processing system and computer system thereof. The audio data transmission method includes providing an audio data, performing an encryption process upon the audio data according to an encryption standard, transmitting the encrypted audio data to an audio device according to a link standard, and utilizing the audio device to perform a decryption process upon the encrypted audio data.

### BACKGROUND OF THE INVENTION

1. Field of the Invention

The invention relates to audio data transmission, and more particularly, to a method for encrypting audio data and then transmitting the encrypted audio data via a high definition audio link, and an apparatus thereof.

2. Description of the Prior Art

More and more consumers have moved their personal computers to their living rooms in order to enjoy digital music and movies with multi-channel audio systems and large-screen televisions. This trend indicates that consumers might consider connecting more advanced speakers to their computers; however, if the audio subsystem of the computer (whether integrated or external) cannot match the high level of the advanced speaker, the overall playing quality of the digital media will be influenced. In addition, reproducing two audio streams on the computer simultaneously is now a common request; for example, consumers might want to play a symphony in the study while playing a movie in the living room. This cannot be accomplished with conventional audio solutions. High Definition Audio (HD Audio) standard defined by Intel, however, are more advanced than previous audio standards. HD Audio can support up to 8 audio channels at 192 kHz/32 bits, while the conventional AC97 standard can only support up to 6 channels at 48 kHz/20 bits. Therefore, by introducing the new High Definition Audio standard, better audio quality could be achieved to satisfy users' needs.

However, No matter whether it is the currently commonly used AC97 standard or the newly developed HD Audio standard that is adopted, conventional computer systems and audio systems still use a data format that can be directly decoded and played, such as the pulse code modulation (PCM) format, to store and transmit audio data. This means that audio data are vulnerable to theft by illegal users (i.e., hackers) during the course of storage and transmission, leading to flawed protection of both personal privacy and intellectual property rights.

### SUMMARY OF THE INVENTION

Therefore, one of the objectives of the present invention is to introduce, in computer systems or audio systems, encryption techniques, which encrypt audio data during the course of audio data storage or transmission, so as to ensure that, even if the encrypted audio data is subject to theft by an illegal user, the actual content of the audio data will not be known because of the encryption.

According to an embodiment of the claimed invention, an audio processing system comprises an audio data source, a host system and an audio device. The audio data source is utilized to provide audio data. The host system, coupled to the audio data source, is utilized to receive the audio data and perform an encryption process upon the audio data according to an encryption standard. The audio device coupled to the host system via a link standard is utilized to receive the audio data encrypted by the host system according to the link standard and perform a decryption process upon the encrypted audio data.

According to another embodiment of the claimed invention, an audio data transmission method comprises providing audio data; performing an encryption process upon the audio data according to an encryption standard; transmitting the encrypted audio data to an audio device via a link standard; and utilizing the audio device to perform a decryption process upon the encrypted audio data.

Moreover, according to yet another embodiment of the claimed invention, a computer system comprises an audio data source, a host system and an audio CODEC. The audio data source is utilized to provide audio data. The host system, coupled to the audio data source, is utilized to receive the audio data and perform an encryption process upon the audio data according to an encryption standard. The audio CODEC, coupled to the host system via a link standard, is utilized to receive the audio data encrypted by the host system according to the link standard and perform a decryption process upon the encrypted audio data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an encrypted audio data transmitting device according to an exemplary embodiment of the present invention.

FIG. 2 is a diagram of audio data complying with High Definition Audio standard.

FIG. 3 is a diagram illustrating the garbage-data padding and encryption process that the encrypted audio data transmitting device in FIG. 1 performs on the 48 kHz/2 ch/24 bit audio data to be transmitted.

FIG. 4 is a diagram illustrating the garbage-data padding and encryption process that the encrypted audio data transmitting device in FIG. 1 performs on the 48 kHz/8 ch/24 bit audio data to be transmitted.

FIG. 5 is a diagram illustrating the garbage-data padding and encryption process that the encrypted audio data transmitting device in FIG. 1 performs on the 192 kHz/2 ch/24 bit audio data to be transmitted.

FIG. 6 is a diagram illustrating the garbage-data padding and encryption process that the encrypted audio data transmitting device in FIG. 1 performs on the 192 kHz/8 ch/24 bit audio data to be transmitted.

### DETAILED DESCRIPTION

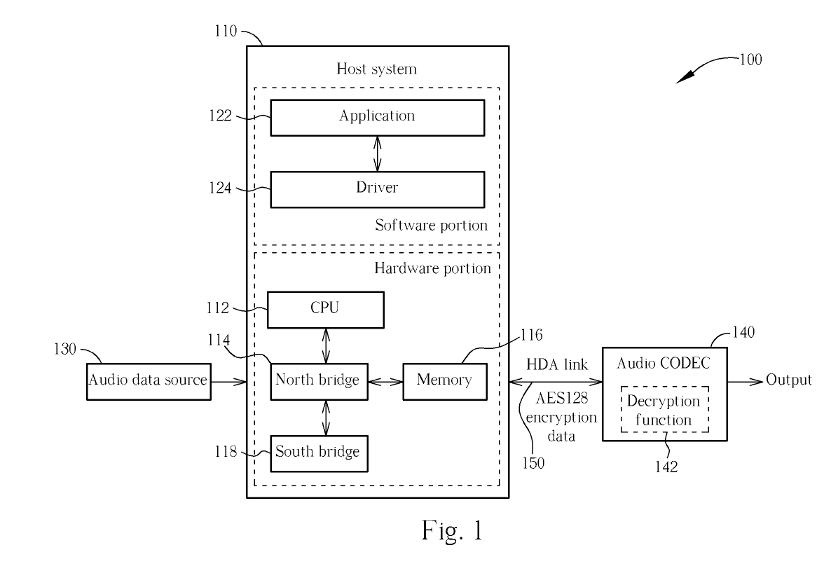

Please refer to FIG. 1, which is a diagram of an encrypted audio data transmitting device 100 according to an exemplary embodiment of the present invention. This embodiment takes a widely seen personal computer system as an example to illustrate the principle of the present invention; however, as those skilled in the art will readily observe, the application of the present invention is not limited to personal computer systems, and any audio system that might be invaded by an illegal user (for example, an audio system connected to the Internet) falls in the field to which the present invention applies. In this embodiment, the encrypted audio data transmitting device 100 shown in FIG. 1 comprises a host system 110, which, in this embodiment, is realized by a personal computer and its computational capacity. Such a host system 110 typically operates on a combination of a hardware portion and a software portion. In terms of hardware the host system 110 generally comprises a central processing unit (CPU) 112, a Northbridge 114 coupled to the CPU 112, for communicating with a memory 116 and other units having fast accessing speed, a Southbridge 118 coupled to the Northbridge 114, for communicating with numerous peripheral devices of the host system 110, and other commonly known units not shown in FIG. 1. In terms of software the host system 110 generally comprises an upper layer application 122 and a lower layer driver 124. Commonly seen examples of the application 122 include multimedia processing and playing program, or any other programs implemented for processing the audio data. The driver 124 is utilized to handle communications between the hardware portion and the software portion. The host system 110 receives audio data from an audio data source 130, encrypts the audio data by utilizing the encryption function of the application 122, and transmits the encrypted audio data to an audio CODEC 140 via an audio link 150. Then the audio CODEC 140 decrypts the encrypted audio data for playing the audio data.

In this embodiment, the audio data source 140, which stores video and audio multimedia data, can be a DVD optical disc storage device, including those complying with next-generation DVD standards such as HD-DVD or Blu-ray specifications. However, the present invention is not limited to the above-mentioned embodiment; any device or signal source storing or transmitting audio data can be viewed as the audio data source 130 in FIG. 1. In order to work with the implementation of the present invention, the audio CODEC 140 is provided with a decryption function 142 in accordance with the encryption operation applied upon the audio data by the host system 110. The decryption function 142 of the audio CODEC 140 can be implemented by hardware or software, which can be easily accomplished by those skilled in the art. Moreover, an HDA link with high transmission bandwidth is preferably adopted as the audio link 150 connecting the audio CODEC 140 and the host system 110 (more specifically the Southbridge 118 in this embodiment), in order to accommodate the transmission of the encrypted audio data. However, as those skilled in the art can readily appreciate, the present invention is not limited by the above-mentioned embodiment; other conventional or innovative audio link techniques could also be utilized in the present invention.

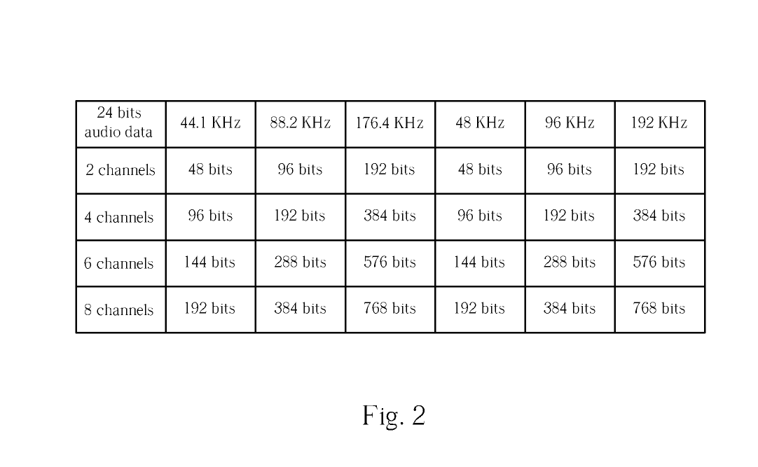

In this embodiment, the host system 110 uses the Advanced Encryption Standard (AES), such as AES128, to encrypt the audio data. Please refer to the table in FIG. 2. In the HD Audio standard, a sampling rate for sampling the audio data can be chosen from the sampling rates of 44.1 kHz, 88.2 kHz, 176.4 kHz, 48 kHz, 96 kHz, and 192 kHz, and the HD audio output can contain 2, 4, 6, 8, or even more than 8 channels of audio data, wherein for each combination of configuration, data can be transmitted in unit of frames with a corresponding bit length. The encryption process of the present embodiment encrypts the audio data having different sampling rates and different channels into uniform 768-bit encrypted data. If the length of the audio data before encryption is less than 768 bits (i.e., in most cases), garbage data will be padded into the frames before the encryption to make the total data length reach a nominal amount. Then the audio data along with the garbage data is transformed into six 128-bit (768 bits in total) encrypted data according to the AES128 standard.

Please note that the transmitting rate of the frames is 48 KHz in the HD Audio standard; therefore, the audio data having a sampling rate of 44.1 kHz needs to be processed additionally. In this embodiment, the additional process of the audio data whose sampling rate is 44.1 kHz is, for every 160 frames of the audio data transmitted, to insert cadences in a pattern of “12-11-11-12-11-11-12-11-11-12-11-11-11-(repeat)”, wherein “-” means no data is transmitted, as prescribed in section 5.4 (pages 83-86) of “High Definition Audio Specification, Revision 1.0”, published on Apr. 15, 2004, by Intel Corporation. That is to say, in every 160 frames, there are 147 frames containing audio data and 13 frames having no audio data. The audio data whose sampling rate is 88.2 kHz or 176.4 kHz could be processed by the same principle. Since a skilled person will readily appreciate the above process after reading the disclosure, further description is herein omitted.

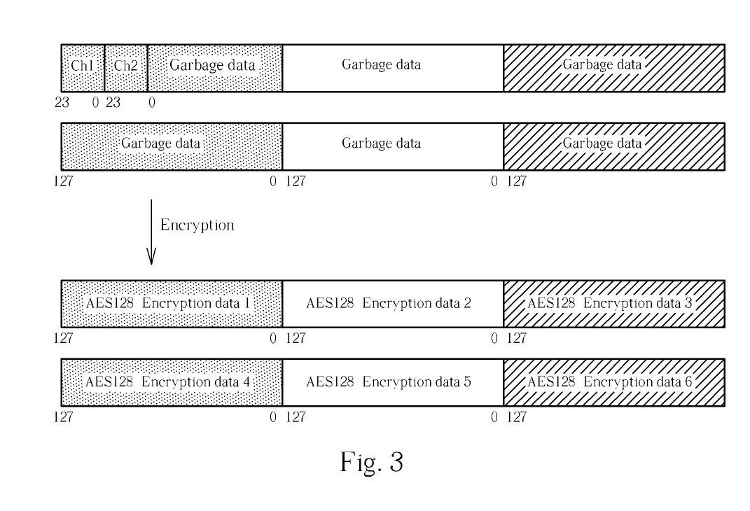

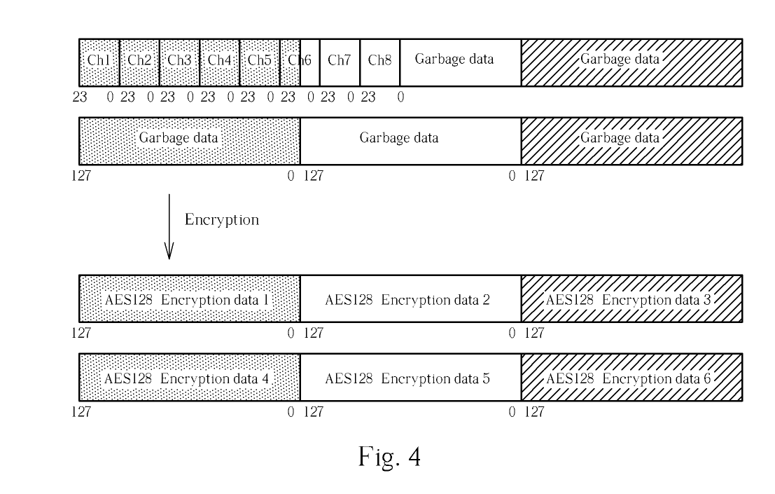

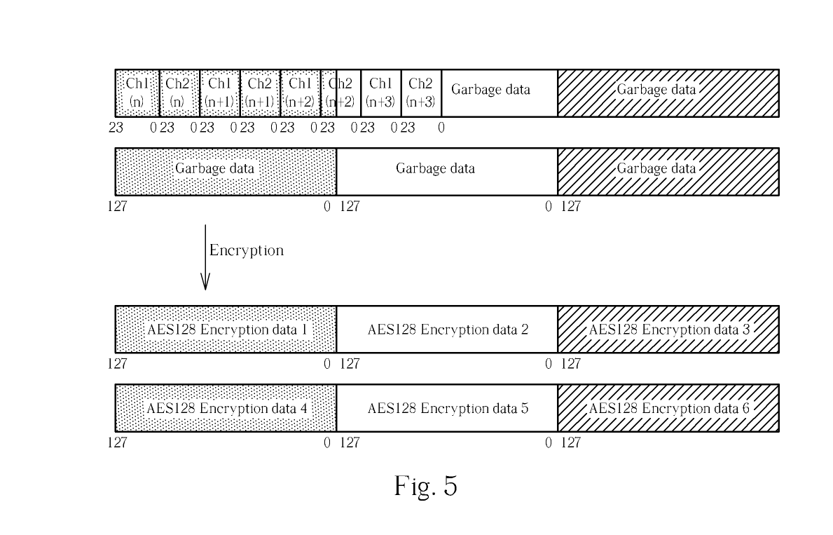

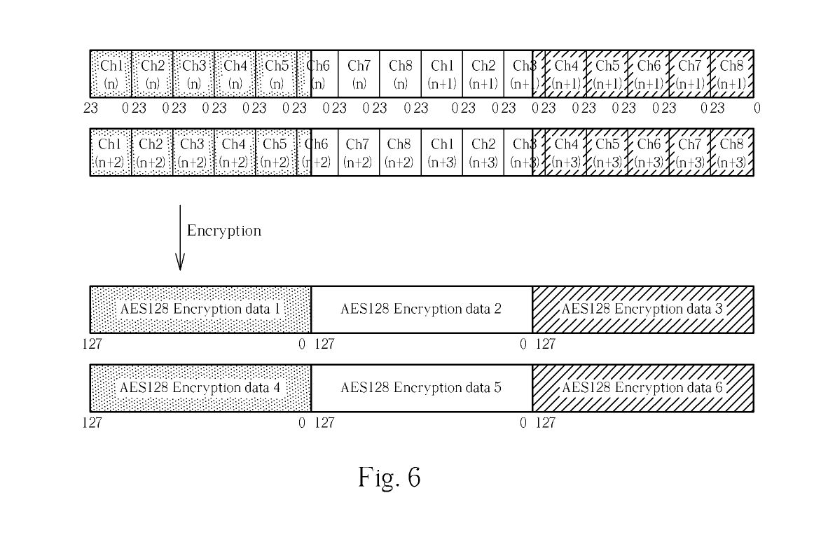

Please refer to FIG. 3, which illustrates the garbage-data padding and encryption process that the encrypted audio data transmitting device 100 in FIG. 1 performs on the 48 kHz/2 ch/24 bit audio data to be transmitted (i.e. the sampling rate is 48 kHz, 2 channels, and the data amount at each sampling of each channel is 24 bits). Because the nominal data amount is 768 bits while the data amount of the audio data is only 48 bits (i.e. 24 bits*2 channels*1), the remaining 720 bits are padded with garbage data, making the data amount reach the nominal amount, i.e., 768 bits. Then the 768-bit data is encrypted to form six 128-bit encrypted data, and the encrypted data is stored in a memory device before it is transmitted to the audio CODEC 140 via the HDA link 150. Similarly, FIG. 4, FIG. 5 and FIG. 6 illustrate the respective garbage-data padding and encryption process that the encrypted audio data transmitting device 100 in FIG. 1 performs on the 48 kHz/8 ch/24 bit, 192 kHz/2 ch/24 bit, and 192 kHz/8 ch/24 bit audio data to be transmitted.

The detailed operating procedure of the AES encryption standard utilized in the present invention will be readily appreciated by a skilled person after reading the disclosure of the present invention; therefore, further description is herein omitted. Those skilled in encryption techniques should understand that the encrypted audio data transmitting device 100 and the encryption method thereof are not limited to apply the AES encryption standard; other encryption techniques that could achieve the objective of data security during transmission or storage of the audio data can also be adopted in the present invention. Although the present invention is not limited to using HDA links, since a significant amount of non-audio data, such as padded garbage data, is introduced to increase the security of encryption when the audio data is encrypted according to AES or other encryption standards, it is preferred that the link used to transmit encrypted data has a high transmission bandwidth, such as HDA link or other serial links. Moreover, the audio data received from the audio data source 130 by the host system 110 may include other standardized or proprietary encryption format. In this situation, the present invention is still applicable as long as the software portion of the host system 110 (i.e., the application 122 and the driver 124) can decrypt, conforming to said standardized or proprietary encryption format, the audio data before performing the designed encryption (i.e., AES128) of the present invention.

Briefly summarized, the present invention utilizes software to encrypt and protect audio data in order to prevent theft of said audio data by illegal users during transmission and storage. When the audio device (e.g., the audio CODEC 140) utilized for processing and playing audio data receives the encrypted data, it can obtain the original audio data by decrypting the encrypted data, thereby achieving the objective of securing the contents of the audio data.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An audio processing system, comprising:
an audio data source, for providing audio data;
a host system, coupled to the audio data source, for receiving the audio data and performing an encryption process upon the audio data according to an encryption standard; and
an audio device, coupled to the host system via a link standard, for receiving the audio data encrypted by the host system according to the link standard and performing a decryption process upon the encrypted audio data.

2. The audio processing system of claim 1, wherein the host system is a personal computer.

3. The audio processing system of claim 2, wherein the host system further comprises an application, for performing the encryption process.

4. The audio processing system of claim 1, wherein the encryption standard is an AES encryption standard.

5. The audio processing system of claim 1, wherein the link standard is an HDA link.

6. The audio processing system of claim 5, wherein the audio device is coupled to a Southbridge of the host system via the HDA link.

7. The audio processing system of claim 1, wherein the audio device is an audio CODEC.

8. The audio processing system of claim 1, wherein the audio data source is a DVD optical disc storage device.

9. An audio data transmitting method, comprising:
providing audio data;
performing an encryption process upon the audio data according to an encryption standard;
transmitting the encrypted audio data to an audio device according to a link standard; and
utilizing the audio device to perform a decryption process upon the encrypted audio data.

10. The audio data transmitting method of claim 9, further comprising:
playing the audio data decrypted by the audio device.

11. The audio data transmitting method of claim 9, wherein the encryption standard is an AES encryption standard.

12. The audio data transmitting method of claim 9, wherein the link standard is an HDA link.

13. The audio data transmitting method of claim 9, wherein the audio device is an audio CODEC.

14. The audio data transmitting method of claim 9, wherein the audio data is provided by a DVD optical disc storage device.

15. A computer system, comprising:
an audio data source, for providing audio data;
a host system, coupled to the audio data source, for receiving the audio data and performing an encryption process upon the audio data according to an encryption standard; and
an audio CODEC, coupled to the host system via a link standard, for receiving the audio data encrypted by the host system according to the link standard and performing a decryption process upon the encrypted audio data.

16. The computer system of claim 15, wherein the host system further comprises an application, for performing the encryption process.

17. The computer system of claim 15, wherein the encryption standard is an AES encryption standard.

18. The computer system of claim 15, wherein the link standard is an HDA link.

19. The computer system of claim 18, wherein the audio CODEC is coupled to a Southbridge of the host system via the HDA link.

20. The computer system of claim 15, wherein the audio data source is a DVD optical disc storage device.
